(19) United States
(12) Patent Application Publication
(10) Pub. No.: US 2026/0188569 A1
(43) Pub. Date: Jul. 2, 2026

(54) INDUCTOR DEVICE

(71) Applicant: HUAWEI TECHNOLOGIES CO., LTD., Shenzhen (CN)

(72) Inventors: Tianxiao Chen, Shenzhen (CN); Pedro André Martins Bezerra, Munich (DE); Zhengyan He, Dongguan (CN); Jinlong Wang, Dongguan (CN)

(73) Assignee: HUAWEI TECHNOLOGIES CO., LTD., Shenzhen (CN)

(21) Appl. No.: 19/550,147

(22) Filed: Feb. 25, 2026

Related U.S. Application Data
(63) Continuation of application No. PCT/CN2023/140613, filed on Dec. 21, 2023.

(51) Int. Cl. H01F 27/34; H01F 3/14; H01F 27/28

(52) U.S. Cl. CPC H01F 27/34; H01F 3/14; H01F 27/2804; H01F 27/2823; H01F 27/2895; H01F 2027/348

(57) ABSTRACT

An inductor device comprises an inductor core; and one or more inductor windings wound around the inductor core. The inductor core is formed to at least partially embed a part of the one or more inductor windings. A cross section of the inductor core comprises a four-sided winding window in which at least partially embedded part of the one or more inductor windings is arranged within the inductor core. The inductor core comprises air gaps extending from the four sides of the winding window. The winding window comprises at each side of the winding window a respective winding clearance in which no inductor windings are arranged. At least one of the four winding clearances has a non-uniform shape.

### CROSS-REFERENCE TO RELATED APPLICATIONS

This application is a continuation of International Application No. PCT/CN2023/140613, filed on Dec. 21, 2023, the disclosure of which is hereby incorporated by reference in its entirety.

### TECHNICAL FIELD

The disclosure relates to an inductor device and a converter, for example an LLC (inductor-inductor-capacitor)-converter. The disclosure particularly relates to an X-shape winding structure with distributed magnetic air gaps.

### BACKGROUND

In telecom and data center applications, Board Mounted Power (BMP) modules are utilized for converting high direct current (DC) voltage to chip-level voltage. These applications typically operate with an input voltage within a specific range, e.g. 36V˜72V, and with a fixed output voltage, e.g. 12V. As the power rating keeps increasing, the output current can become significantly high. The LLC converter is extensively utilized in these power modules due to its high efficiency and high-power density. This is primarily because it facilitates the soft-switching of the switching devices, which enhances the overall efficiency of the power conversion process. However, to maintain sufficient voltage regulation capability, a large resonant inductor is required. This is where one of the primary challenges in designing an efficient converter arises. To prevent saturation of the inductor, a large air gap is necessary. This large air gap, however, generates fringe flux around itself, leading to substantial eddy current losses in its vicinity. These eddy current losses significantly impact the efficiency of the converter, making it one of the major obstacles in designing a high-efficiency converter. Therefore, there is a need for innovative solutions to address this issue.

### SUMMARY

This disclosure provides a solution for a high-efficiency converter. The disclosure particularly presents a new design for a resonant inductor, specifically addressing the issue of eddy current losses caused by the fringe flux from the air gap.

The present disclosure provides a resonant inductor which addresses the issue of eddy current losses caused by the fringe flux from the air gap. Unlike conventional designs that attempt to keep fringe flux away, the solution according to this disclosure leverages it. This can be achieved by strategically designing air gaps on all four sides of the winding window, additionally, circular clearances are made on the windings, which allows for homogeneous current distribution within the windings, fully utilizing the available copper area. It aids in the reduction of the alternating current (AC) resistance R_{ac}. As a result, the AC resistance can be reduced by approximately 50% compared with conventional methods, significantly enhancing the overall efficiency of the power module.

The disclosure presents a design that can reduce the severe eddy current losses caused by fringing flux at the air gaps of the resonant inductor in an LLC converter. This design enables much higher copper area utilization ratio in AC resonant inductor.

In some embodiments of the disclosure, a converter design is provided based on one or more of the following three conditions:
1) Distributed air gaps: one or more air gaps may be situated centrally on each side of the winding window, totally four sides for one winding. The term ‘center’ can be defined as the location of the air gap within the range of 30% to 70% of the winding window edge length.
2) Non-uniform winding clearance: A winding design is applied where the distance between the winding outline and the side or edge of the winding window is non-uniform, more specifically, a winding design that incorporates a specially shaped clearance, as opposed to a clearance with a constant distance. FIGS. 2a to 2d described below provide illustrations of non-uniform winding clearances. In some embodiments, a winding design can be applied that exhibits non-uniform clearances on more than two sides at the same time. Examples are shown below with respect to FIGS. 4 and 8.
   This disclosure encompasses all types of windings, regardless of whether they are composed of solid copper, multi-layered PCB, or Litz wire windings. Manufacturing tolerance is permissible, and any clearance that arises as a byproduct of the manufacturing process, rather than as a result of intentional design, is not regarded as a non-uniform winding according to this disclosure.
3) An X-shape design of the windings is confined within a designated area referred to as the “winding restricted area”. As illustrated in FIG. 3 and described below, this restricted area is defined by the projection of the core shape onto the winding, creating a shadow. This shadowed region delineates the boundaries of the restricted area. Thus, the winding design within this area is relevant for the design according to the disclosure. Outside this area, the winding design can be arbitrary.

Embodiments of the disclosure introduce an inductor design that incorporates four air gap regions surrounding the inductor winding, and that has special-shape clearance on the windings under the core area to avoid fringe flux.

In order to describe the disclosure in detail, the following terms and notations will be used.
PCB Printed Circuit Board
LLC inductor-inductor-capacitor
AC alternating current

According to a first aspect, the disclosure relates to an inductor device, comprising: an inductor core; and one or more inductor windings wound around the inductor core, the inductor core being formed to at least partially embed a part of the one or more inductor windings; wherein a cross section of the inductor core comprises a four-sided winding window in which the partially embedded at least part of the one or more inductor windings is arranged within the inductor core; wherein the inductor core comprises air gaps extending from the four sides of the winding window; wherein the winding window comprises at each side of the winding window a respective winding clearance in which no inductor windings are arranged, wherein at least one of the four winding clearances has a non-uniform shape.

Such an inductor design is highly efficient compared to existing designs.

Such an inductor device can reduce the severe eddy current losses caused by fringing flux at the air gaps of the inductor. This inductor device design enables much higher copper area utilization ratio in AC inductor.

In an exemplary implementation of the inductor device, the winding window with the winding clearances and the air gaps extending from the four sides of the winding window are formed in a winding restricted area of the inductor device; wherein the winding restricted area is formed by a projection of an outline of the inductor core onto the one or more inductor windings which overlaps the one or more inductor windings.

Such an inductor device provides design flexibility, since only in the winding restricted area a special clearance shape as described above is required. Outside the winding restricted area, the inductor device can be arbitrarily designed.

In an exemplary implementation of the inductor device, the inductor core comprises a top face and a bottom face in opposite direction to the top face, wherein the one or more inductor windings are wound around the inductor core in one or more planes between the top face and the bottom face, wherein the section view of the inductor core defines a plane through the one or more inductor windings orthogonal to the top face and the bottom face.

Such an inductor device can be formed as a 3-dimensional homogeneous block or as a 3-dimensional multilayer block depending on the specific requirements.

In an exemplary implementation of the inductor device, at least two of the four winding clearances have a non-uniform shape.

When two or more of the four winding clearances have a non-uniform shape, the AC resistance of the inductor device can be reduced compared to a design with only a single winding clearance. Implementing a non-uniform shape can also reduce weight of the inductor device.

In an exemplary implementation of the inductor device, the non-uniform shape of the winding clearance results from a non-uniform distance between an outline of the one or more inductor windings and a respective one of the sides of the winding window.

The non-uniform shape of the winding clearance results in reduced AC resistance.

The outline of the inductor windings according to the disclosure is represented by a straight line as can be seen by FIG. 2. Any missing wire in the windings creates a non-uniform shape as can be seen by FIG. 2. The single wires which are connected to a wire bundle have an outline formed as a straight line as illustrated in FIG. 2.

A non-uniform shape resulting from manufacturer tolerance instead of intentional design is not a non-uniform shape according to this disclosure.

In an exemplary implementation of the inductor device, a shape of the winding clearance has a circular-shaped, elliptically-shaped, square-shaped, rectangular shaped, triangular shaped or round convexity or indentation that effects the non-uniform shape of the winding clearance.

This implementation shall cover any possible special shape, not limited to the above-mentioned special shapes.

In an exemplary implementation of the inductor device, the one or more inductor windings are arranged inclined in the winding window to form the non-uniform shape of the winding clearance.

Such an inclined arrangement can be easily produced by rotating a rectangular or square shaped winding structure by some angle around the center of the winding window.

In an exemplary implementation of the inductor device, the winding window is defined by a winding window width and a winding window height; wherein four air gaps are positioned, with two located in a first center area and the remaining two in a second center area; wherein each of these air gap areas features at least one air gap that extends longitudinally throughout the respective area.

Such a design efficiently prevents saturation of the inductor device.

In an exemplary implementation of the inductor device, the first center area is arranged centrally in the winding window within a range of 30% to 70% of the winding window width; and the second center area is arranged centrally in the winding window within a range of 30% to 70% of the winding window height.

Such a design of the center areas efficiently restricts the fringe flux in the center areas. The fringe flux can then be utilized with circular-shaped clearance on the windings to reduce eddy current losses.

In an exemplary implementation of the inductor device, the winding window is square-shaped and the winding clearances are circular-shaped with a radius depending on the winding window width.

In scenarios where a square-shaped winding window area is encircled by four air gaps, an optimal radius for the circular clearance can be provided which results in minimum AC resistance.

In an exemplary implementation of the inductor device, the winding window is rectangular-shaped and the winding clearances are circular-shaped with radii of the clearances depending on the winding window height and the winding window width.

In scenarios where a more general rectangular-shaped winding window area is encircled by four air gaps, an optimal radius for the circular clearance can be provided which results in minimum AC resistance.

In an exemplary implementation of the inductor device, the four winding clearances are circular-shaped to form an X-shaped inductor winding.

An inductor device with X-shaped inductor winding can provide minimum AC resistance.

In an exemplary implementation of the inductor device, the one or more inductor windings are composed of any kind of conductor, PCB-based multi-layer windings, Litz wire windings, stranded cables or any combination thereof.

Any kind of conductor may be for example solid copper. Such a design provides high flexibility by use of different types of inductor windings.

In an exemplary implementation of the inductor device, the one or more inductor windings are composed of PCB-based multi-layer windings, each layer of PCB forming a certain winding clearance to create a circular distance from the respective air gap.

Such inductor device composed of PCB-based multi-layer windings can be easily and efficiently manufactured.

According to a second aspect, the disclosure relates to a converter, comprising an inductor, wherein the inductor corresponds to an inductor device as described above with respect to the first aspect. The converter can be any converter, for example a LLC converter or any other kind of converter in which an inductor is used.

Such a converter provides high-efficiency and high-power density at excellent voltage regulation capacity. Eddy current losses are efficiently mitigated.

According to a third aspect, the disclosure relates to a method for producing an inductor device, the method comprising: producing an inductor core; and one or more inductor windings wound around the inductor core, wherein the inductor core is formed to at least partially embed a part of the one or more inductor windings; wherein the inductor core is produced to have a cross section comprising a four-sided winding window in which the at least partially embedded part of the one or more inductor windings is arranged within the inductor core; wherein the inductor core is produced comprising air gaps extending from the four sides of the winding window; wherein the winding window is manufactured to comprise at each side of the winding window a respective winding clearance in which no inductor windings are arranged, wherein at least one of the four winding clearances has a non-uniform shape.

Such a method allows production of a highly efficient inductor device that can reduce the severe eddy current losses caused by fringing flux at the air gaps of the inductor. This production method can manufacture an inductor device that enables much higher copper area utilization ratio in AC inductor.

### BRIEF DESCRIPTION OF THE DRAWINGS

Further embodiments of the disclosure will be described with respect to the following figures, in which:

FIG. 1 shows four different views of an exemplary inductor device 100 according to the disclosure;

FIG. 2 shows four different views of exemplary winding clearances 150 having non-uniform and uniform shapes;

FIG. 3 shows a top view of an exemplary inductor device 100 illustrating the winding restricted area 210 according to the disclosure;

FIG. 4 shows eight different cross sections of inductor windings 120 according to different embodiments;

FIG. 5a shows a cross section of an AC inductor for an LLC converter illustrating fringe flux 501;

FIG. 5b shows a schematic diagram of an inductor winding 120 illustrating fringe flux 501 and eddy currents 502;

FIG. 5c shows a cross section of an inductor device with circular winding clearance 150;

FIG. 6a shows a cross section of an inductor device 100 with X-shaped inductor windings 120 and square shape winding window 140 according to an embodiment;

FIG. 6b shows a simulation of AC resistance for different circular clearance radii of the square shape winding window 140;

FIG. 6c shows a cross section of an inductor device 100 with X-shaped inductor windings 120 and rectangular shape winding window 140 according to an embodiment;

FIG. 7a shows a cross section of an inductor device with U core with uniform clearance and corresponding AC resistance;

FIG. 7b shows a cross section of an inductor device with E core with two circular clearances and corresponding AC resistance;

FIG. 7c shows a cross section of an inductor device 100 with X-shaped inductor windings 120 according to a first embodiment and corresponding AC resistance;

FIG. 7d shows a cross section of an inductor device 100 with X-shaped inductor windings 120 formed by a multilayer PCB according to a second embodiment;

FIGS. 8a and 8b show four different cross sections of inductor windings 120 with uniform shaped winding clearances 150; and

FIGS. 8c and 8d show four different cross sections of inductor windings 120 with non-uniform shaped winding clearances 150.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the disclosure. The following detailed description, therefore, is not to be taken in a limiting sense, and the scope of the disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

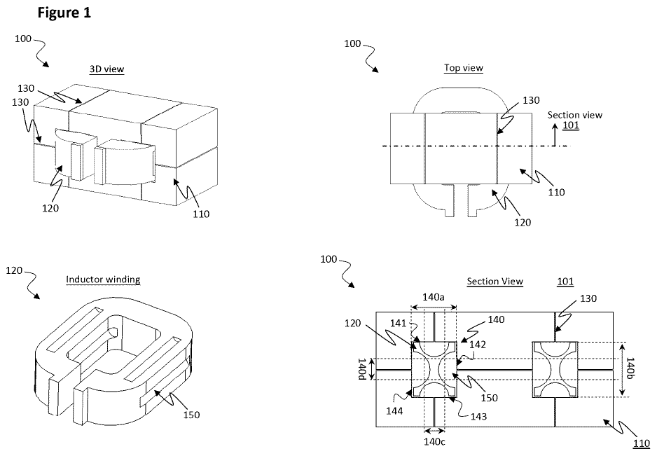

FIG. 1 shows four different views of an exemplary inductor device 100 according to the disclosure. Top left picture shows a 3D view of the inductor device, top right picture shows a top view and bottom right picture shows a core section view, i.e., a cross section 101 of the inductor core. Bottom left picture shows a 3D view of the inductor winding(s).

The inductor device 100 comprises an inductor core 110; and one or more inductor windings 120 wound around the inductor core 110 as shown in the top left picture of FIG. 1. The inductor core 110 is formed to at least partially embed a part of the one or more inductor windings 120 as can be seen from top left picture of FIG. 1.

A cross section 101 of the inductor core 110 as shown in bottom right picture of FIG. 1 comprises a four-sided 141, 142, 143, 144 winding window 140 in which the partially embedded at least part of the one or more inductor windings 120 is arranged within the inductor core 110.

The inductor core 110 comprises air gaps 130 as shown in top left, top right and bottom right pictures of FIG. 1 extending from the four sides 141, 142, 143, 144 of the winding window 140.

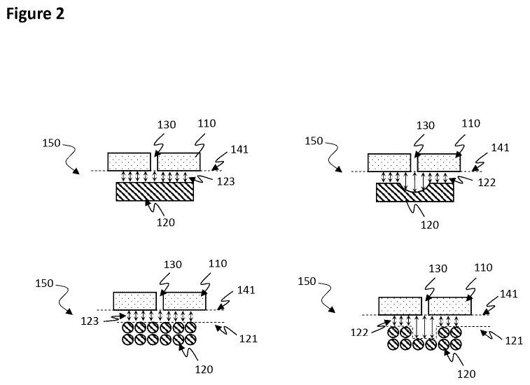

The winding window 140 comprises at each side 141, 142, 143, 144 of the winding window 140 a respective winding clearance 150 as shown in bottom left and right pictures of FIG. 1 in which no inductor windings 120 are arranged. At least one of the four winding clearances 150 has a non-uniform shape. A definition of such a non-uniform shape is illustrated in FIG. 2 in which the two right-side views of FIG. 2 show examples for non-uniform shapes. In the top right view a non-uniform distance 122 is between the side 141 of the winding window 140 and the surface of the winding 120; The winding surface has a section with a circular clearance that results in the non-uniform distance 122. In the bottom right view a non-uniform distance 122 is between the side 141 of the winding window 140 and the outline 121 of the winding 120; a single winding is missing in the winding bundle which results in the non-uniform distance 122.

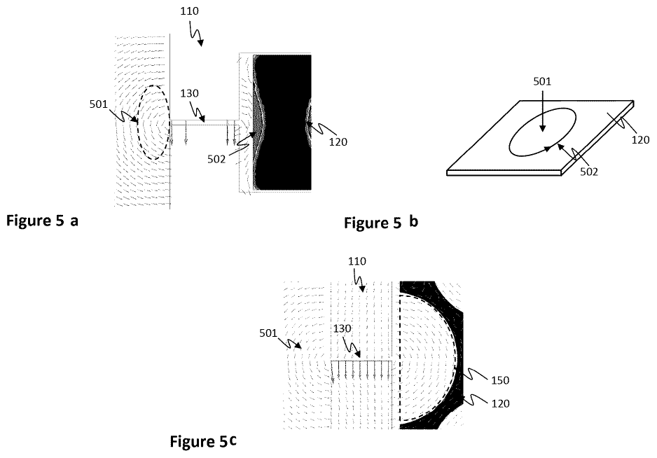

Such an inductor device 100 can reduce the severe eddy current losses caused by fringing flux at the air gaps of the inductor, e.g., as illustrated in FIG. 5a to 5c. This inductor device design enables much higher copper area utilization ratio in AC inductor.

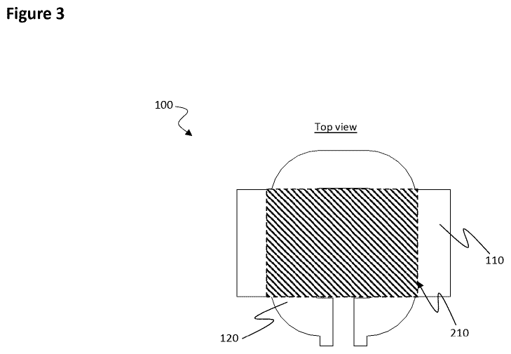

The winding window 140 with the winding clearances 150 and the air gaps 130 extending from the four sides 141, 142, 143, 144 of the winding window 140 may be formed in a winding restricted area 210 of the inductor device 100 as shown in FIG. 3.

The winding restricted area 210 is formed by a projection of an outline of the inductor core 110 onto the one or more inductor windings 120 which overlaps the one or more inductor windings 120.

The inductor core 110 comprises a top face as shown in the top view of top right picture of FIG. 1 and a bottom face in opposite direction to the top face.

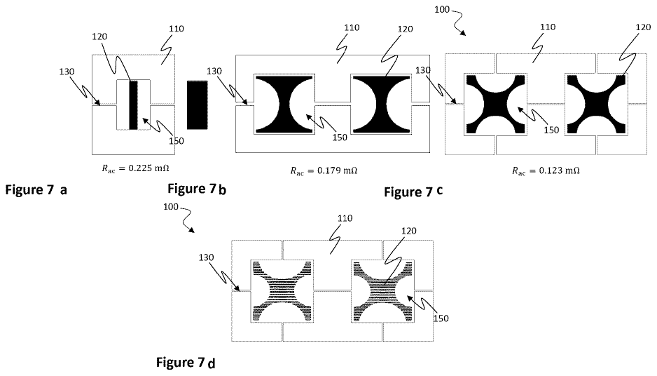

The one or more inductor windings 120 may be wound around the inductor core 110 in one or more planes between the top face and the bottom face, e.g., as shown in FIG. 7d.

The section view 101 of the inductor core 110 as shown in bottom right picture of FIG. 1 defines a plane through the one or more inductor windings 120 orthogonal to the top face and the bottom face.

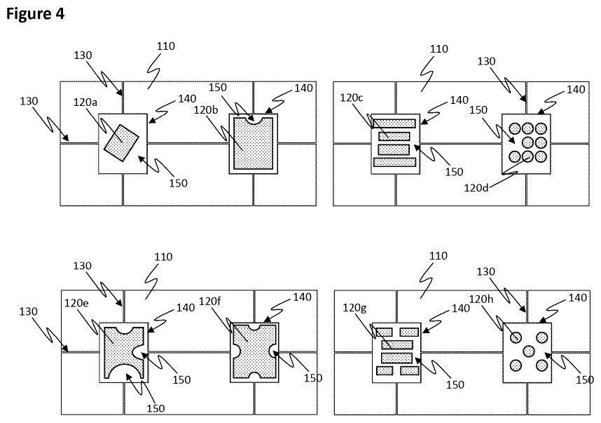

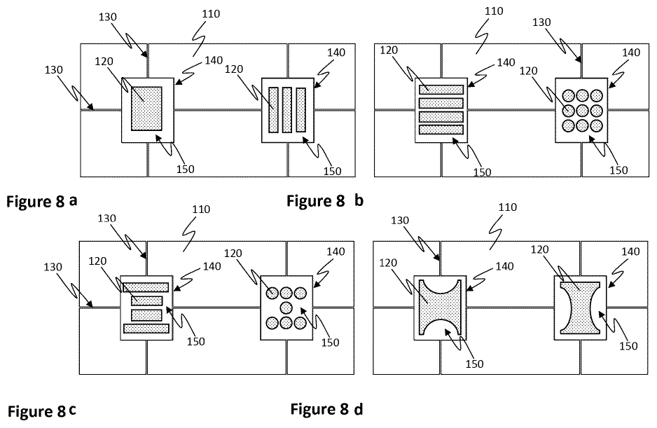

As described above, at least one of the four winding clearances 150 has a non-uniform shape. In another embodiment, at least two of the four winding clearances 150 can have a non-uniform shape. Different embodiments of such winding clearances 150 are shown in FIGS. 4 and 8.

The non-uniform shape of the winding clearance 150 can result from a non-uniform distance 122 between an outline of the one or more inductor windings 120 and a respective one of the sides 141, 142, 143, 144 of the winding window 140 as exemplarily illustrated in FIG. 2.

The outline of the inductor windings according to the disclosure is represented by a straight line as can be seen by FIG. 2. Any missing wire in the windings creates a non-uniform shape as can be seen by FIG. 2. The single wires which are connected to a wire bundle have an outline formed as a straight line as illustrated in FIG. 2.

A non-uniform shape resulting from manufacturer tolerance instead of intentional design is not a non-uniform shape according to this disclosure. A shape of the winding clearance 150 can, for example, have a circular-shaped, elliptically-shaped, square-shaped, rectangular shaped, triangular shaped or round convexity or indentation that effects the non-uniform shape of the winding clearance 150, e.g., as shown in FIGS. 4 and 8.

The one or more inductor windings 120 may be arranged inclined in the winding window 140 to form the non-uniform shape of the winding clearance 150, e.g., as shown in top left picture of FIG. 4.

The winding window 140 can be defined by a winding window width 140a and a winding window height 140b as shown in bottom right picture of FIG. 1.

Four air gaps 130 may be positioned, with two located in a first center area 140c and the remaining two in a second center area 140d as shown in bottom right picture of FIG. 1.

Each of these air gap areas 130 may feature at least one air gap that extends longitudinally throughout the respective area as shown in bottom right picture of FIG. 1.

The first center area 140c may be arranged centrally in the winding window 140 within a range of 30% to 70% of the winding window width 140a as shown in bottom right picture of FIG. 1.

The second center area 140d may be arranged centrally in the winding window 140 within a range of 30% to 70% of the winding window height 140b as shown in bottom right picture of FIG. 1.

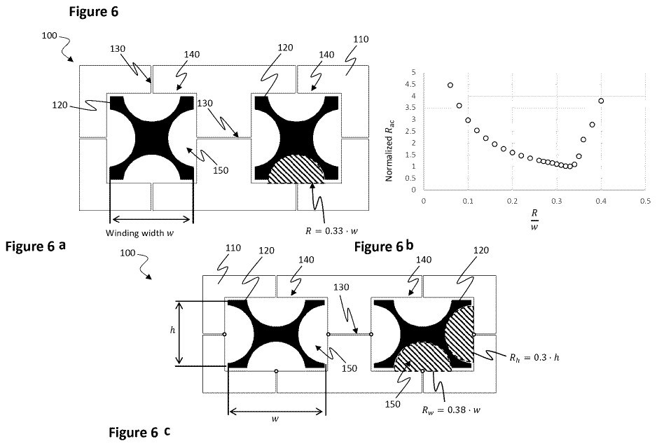

In one embodiment, the winding window 140 can be square-shaped and the winding clearances 150 can be circular-shaped with a radius depending on the winding window width 140a as shown in FIG. 6a, for example.

In another embodiment, the winding window 140 can be rectangular-shaped and the winding clearances 150 can be circular-shaped with radii of the clearances depending on the winding window height 140b and the winding window width 140a as shown in FIG. 6c, for example.

The four winding clearances 150 can be circular-shaped to form an X-shaped inductor winding 120 as shown in FIGS. 6a, 6c, 7c and 7d, for example.

The one or more inductor windings 120 can be composed of any kind of conductor, PCB-based multi-layer windings, Litz wire windings, stranded cables or any combination thereof.

Any kind of conductor may be for example solid copper.

An example for PCB-based multi-layer windings is shown in FIG. 7d.

The one or more inductor windings 120 can be composed of PCB-based multi-layer windings, each layer of PCB forming a certain winding clearance 150 to create a circular distance from the respective air gap 130, e.g., as shown in FIG. 7d.

The disclosure also relates to a converter, comprising an inductor that corresponds to the inductor device 100 described above. The converter can be any converter, for example a LLC converter or any other kind of converter in which an inductor is used.

FIG. 2 shows four different views of exemplary winding clearances 150 having non-uniform and uniform shapes.

The winding clearance 150 is formed at respective sides of the winding window 140 as shown in FIG. 1 between the inductor core 110 and the inductor winding 120 as illustrated in the four views of FIG. 2.

The two left-side views of FIG. 2 show examples for uniform shapes. In the top left view a uniform distance 123 is between the side 141 of the winding window 140 and the surface of the winding 120. In the bottom left view a uniform distance 123 is between the side 141 of the winding window 140 and the outline 121 of the winding 120.

FIG. 3 shows a top view of an exemplary inductor device 100 illustrating the winding restricted area 210 according to the disclosure.

FIG. 4 shows eight different cross sections of inductor windings 120 according to different embodiments.

In a first cross section (top left), the inductor winding 120a is arranged inclined in the winding window 140 resulting in non-uniform shape of the winding clearance 150. The shape follows an outline from a first distance (large distance) linear to a second distance (small distance) and linear to a third distance (another large distance), similar to two triangles. The inductor winding 120a is rectangular shaped and may be formed as a single winding or as different winding layers (not shown here).

In a second cross section (second top left), the inductor winding 120b has four sides that are arranged parallel to the winding window 140. One side of the inductor winding 120b has a round convexity or indentation that results in a non-uniform shape of the winding clearance 150. The inductor winding 120b is rectangular shaped with said convexity at one side and may be formed as a single winding or as different winding layers (not shown here).

In a third cross section (third top left), the inductor winding 120c is composed of an exemplary number of four layers, e.g., formed from a multilayer board or PCB. Two of the inner layers are smaller in width than the two outer layers which results in a non-uniform shape of the winding clearance 150 at two sides of the winding window 140.

In a fourth cross section (top right), the inductor winding 120d is composed of an exemplary number of eight wires (e.g., Litz wires or stranded cables). Such shape corresponds to a square cable bundle of nine wires in which one wire is missing at one side of the winding window 140 which results in a non-uniform shape of the winding clearance 150 at said one side of the winding window 140.

In a fifth cross section (bottom left), the inductor winding 120e has four sides that are arranged parallel to the winding window 140. Three sides of the inductor winding 120e have a round convexity or indentation that results in a non-uniform shape of the winding clearance 150. The inductor winding 120e is rectangular shaped with said convexities at three sides and may be formed as a single winding or as different winding layers (not shown here).

In a sixth cross section (second bottom left), the inductor winding 120f has four sides that are arranged parallel to the winding window 140. All four sides of the inductor winding 120f have a round convexity or indentation that results in a non-uniform shape of the winding clearance 150. The inductor winding 120f is rectangular shaped with said convexities at all four sides and may be formed as a single winding or as different winding layers (not shown here).

In a seventh cross section (third bottom left), the inductor winding 120g is composed of an exemplary number of four layers, e.g., formed from a multilayer board or PCB. Two of the inner layers are smaller in width than the two outer layers which results in a non-uniform shape of the winding clearance 150 at two sides of the winding window 140. The two outer layers are interrupted by a gap which results in a non-uniform shape of the winding clearance 150 at the other two sides of the winding window 140.

In an eighth cross section (bottom right), the inductor winding 120h is composed of an exemplary number of five wires (e.g., Litz wires or stranded cables). Such shape corresponds to a square cable bundle of nine wires in which four outer middle wires are missing which results in a non-uniform shape of the winding clearance 150 at each of the four sides of the winding window 140.

FIG. 5a shows a cross section of an AC inductor for an LLC converter illustrating fringe flux 501.

In a closed-loop LLC converter designed to regulate output voltage, the resonant inductor often necessitates significant inductance to ensure adequate regulation capacity. Consequently, a large air gap 130 is required to prevent saturation. However, this large air gap 130 gives rise to fringe flux 501, which, when it passes through a winding 120, generates substantial losses (eddy current 502) as shown in FIG. 5a. These losses are represented as a part of total conduction losses for an AC inductor.

FIG. 5b shows a schematic diagram of an inductor winding 120 illustrating fringe flux 501 and eddy currents 502. Fringe flux 501 results in eddy current 501 as schematically shown in FIG. 5b.

To mitigate these eddy current losses 502, a circular clearance 150 is incorporated into the winding 120 as shown in FIG. 5c. This modification reduces the amount of fringe flux 501 that passes perpendicularly through the winding 120 surface, thereby diminishing losses. However, these clearances 150 also decrease the copper area available for inductor current to pass through, creating a trade-off between the losses generated by the fringe flux 501 and the conduction losses incurred by the inductor current flowing through the winding 120.

FIG. 6a shows a cross section of an inductor device 100 with X-shaped inductor windings 120 and square shape winding window 140 according to an embodiment. FIG. 6b shows a simulation of AC resistance for different circular clearance radii of the square shape winding window 140.

For such an embodiment, where a square-shaped winding window area is encircled by four air gaps, simulations have shown that the optimal radius for the circular clearance 150 is approximately 0.33 times the width of the winding window width w.

This relationship is illustrated in FIG. 6b where the normalized AC resistance has a minimum at 0,33.

The embodiment shown in FIG. 6a illustrates the optimal design for a solid inductor winding. The optimal radii for the circular clearances 150 have been determined through Ansys simulations, with the corresponding values depicted in FIG. 6b.

FIG. 6c shows a cross section of an inductor device 100 with X-shaped inductor windings 120 and rectangular shape winding window 140 according to an embodiment.

For a more general rectangular-shaped winding as shown in FIG. 6c, the Ansys 2D simulations give the optimal radii of the clearances 150 within the range of

$$0.65 < \frac{{R}_{h}}{h} + \frac{{R}_{w}}{w} < 0.7 .$$

This conclusion aligns closely with the findings for the square-shaped winding, demonstrating a consistent pattern in optimal clearance radius across different winding shapes.

FIG. 7a shows a cross section of an inductor device with U core with uniform clearance 150 and corresponding AC resistance of 0.225 mΩ. FIG. 7b shows a cross section of an inductor device with E core with two circular clearances 150 and corresponding AC resistance of 0.179 mΩ. FIG. 7c shows a cross section of an inductor device 100 with X-shaped inductor windings 120 according to a first embodiment and corresponding AC resistance of 0.123 mΩ.

This particular embodiment shown in FIG. 7c significantly enhances the efficiency of the inductor design. Compared to the more conventional designs shown in FIGS. 7a and 7b, this embodiment shown in FIG. 7c can reduce the R_{ac} of the inductor by approximately 50%. When contrasted with the 2 air-gap design shown in FIG. 7b featuring optimal circular clearance, the X winding design can achieve a 30% reduction in R_{ac}.

Additionally, this design shown in FIG. 7c does not necessitate precise and enough spacing between the winding and the core, which aids in decreasing the core's profile. Furthermore, it does not require high-precision manufacturing, thereby avoiding any potential cost increases.

FIG. 7d shows a cross section of an inductor device 100 with X-shaped inductor windings 120 formed by a multilayer PCB according to a second embodiment.

Analogous to the first embodiment shown in FIG. 7c, this design can be applied to other types of winding, such as a PCB-based multi-layer winding, as depicted in FIG. 7d. The illustrated design in FIG. 7d employs an exemplary 24-layer PCB layout (any other number of layers may also be applied), wherein each layer is designed with a certain clearance 150 to create a circular distance from the air gap 130.

The benefit of this embodiment lies in the ease of designing and manufacturing a PCB-based multilayer winding. The clearance is inherently incorporated during the design phase, eliminating the need for any post-processing. This approach does not incur any additional costs during the manufacturing process.

FIGS. 8a and 8b show four different cross sections of inductor windings 120 with uniform shaped winding clearances 150.

In a first cross section (left side of FIG. 8a), the inductor winding 120 is arranged in the center of the winding window 140 resulting in uniform shape of the winding clearance 150.

In a second cross section (right side of FIG. 8a), the inductor winding 120 is composed of a multilayer with an exemplary number of three layers that are vertically aligned. When considering the outline of the three layers, this configuration results in a uniform shape of the winding clearance 150.

In a third cross section (left side of FIG. 8b), the inductor winding 120 is composed of an exemplary number of four layers that are horizontally aligned. When considering the outline of the four layers, this configuration results in a uniform shape of the winding clearance 150.

In a fourth cross section (right side of FIG. 8b), the inductor winding 120 is composed of a wire bundle of an exemplary number of nine wires. When considering the outline of the wire bundle, this configuration results in a uniform shape of the winding clearance 150.

FIGS. 8c and 8d show four different cross sections of inductor windings 120 with non-uniform shaped winding clearances 150.

In a first cross section (left side of FIG. 8c), the inductor winding 120 is composed of an exemplary number of four layers, e.g., formed from a multilayer board or PCB. Two of the inner layers are smaller in width than the two outer layers which results in a non-uniform shape of the winding clearance 150 at two sides of the winding window 140.

In a second cross section (right side of FIG. 8c), the inductor winding 120 is composed of an exemplary number of seven wires (e.g., Litz wires or stranded cables). Such shape corresponds to a square cable bundle of nine wires in which two wires are missing at two sides of the winding window 140 which results in a non-uniform shape of the winding clearance 150.

In a third cross section (left side of FIG. 8d), the inductor winding 120 has two linear vertical sides and two horizontal circular-shaped sides. These two circular-shaped sides result in a non-uniform shape of the winding clearance 150.

In a fourth cross section (right-hand side of FIG. 8d), the inductor winding 120 has two linear horizontal sides and two vertical circular-shaped sides. These two circular-shaped sides result in a non-uniform shape of the winding clearance 150.

The inductor design presented in this disclosure can be applied, for example, in Telecom Applications. The improved inductor design can be utilized in board-mounted power modules in telecommunication systems, for example, where it can enhance the efficiency of power conversion, reducing energy loss and improving system reliability.

The inductor design presented in this disclosure can be applied, for example, in Data Center Applications. Data centers demand high-efficiency power conversion to manage vast amounts of data. The disclosed inductor design can be used in power modules to reduce energy consumption, thereby contributing to more sustainable and cost-effective operations.

The inductor design presented in this disclosure can be applied, for example, in other high-power applications. The disclosed design can also be implemented in other high power applications such as electric vehicles, renewable energy systems, and industrial power supplies, where AC inductors are used. The conduction losses can be significantly reduced.

The inductor design presented in this disclosure offers the following beneficial effects: 1) Significantly Reduced Conduction Losses: The disclosed inductor design boasts high efficiency, demonstrating a marked reduction in the alternating current resistance (R_{ac}) of the winding by approximately 50% compared to prior solutions. 2) Compact Core Profile: The design features a low-profile core, resulting in high power volume density. 3) Simplified Design and Fabrication: The disclosed inductor device can be easily designed and fabricated, for example by using a PCB planar inductor, leading to cost-effectiveness. 4) Weight Reduction: By eliminating unnecessary copper, the disclosed inductor design significantly reduces weight, thus increasing power mass density.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as specifically described herein.

What is claimed is:

1. An inductor device, comprising:
an inductor core; and
one or more inductor windings wound around the inductor core, wherein a part of the one or more inductor windings is at least partially embedded in the inductor core;
wherein a cross section of the inductor core comprises a four-sided winding window in which the at least partially embedded part of the one or more inductor windings is arranged;
wherein the inductor core comprises air gaps extending from the four sides of the winding window;
wherein the winding window comprises, at each side of the winding window, a respective winding clearance in which no inductor windings are arranged, wherein at least one of the four winding clearances has a non-uniform shape where a distance between a winding outline and a side or edge of the winding window is non-uniform.

2. The inductor device of claim 1, wherein the winding window with the winding clearances and the air gaps extending from the four sides of the winding window are formed in a winding restricted area of the inductor device; and
wherein the winding restricted area is formed by a projection of an outline of the inductor core onto the one or more inductor windings which overlaps the one or more inductor windings.

3. The inductor device of claim 1, wherein the inductor core comprises a top face and a bottom face in opposite direction to the top face; and
wherein the one or more inductor windings are wound around the inductor core in one or more planes between the top face and the bottom face.

4. The inductor device of claim 1, wherein at least two of the four winding clearances have a non-uniform shape.

5. The inductor device of claim 1, wherein a shape of the winding clearance has a circular-shaped, elliptically-shaped, square-shaped, rectangular shaped, triangular shaped or round convexity or indentation.

6. The inductor device of claim 1, wherein the one or more inductor windings are inclined in the winding window to form the non-uniform shape of the winding clearance.

7. The inductor device of claim 1, wherein the winding window is defined by a winding window width and a winding window height;
wherein four air gaps are positioned, with two located in a first center area and the remaining two in a second center area;
wherein each of the center areas comprises at least one air gap that extends longitudinally throughout the respective center area.

8. The inductor device of claim 7, wherein the first center area is arranged centrally in the winding window within a range of 30% to 70% of the winding window width; and
wherein the second center area is arranged centrally in the winding window within a range of 0% to 70% of the winding window height.

9. The inductor device of claim 7, wherein the winding window is square-shaped and the winding clearances are circular-shaped with a radius depending on the winding window width.

10. The inductor device of claim 7, wherein the winding window is rectangular-shaped and the winding clearances are circular-shaped with radii of the clearances depending on the winding window height and the winding window width.

11. The inductor device of claim 1, wherein the four winding clearances are circular-shaped to form an X-shaped inductor winding.

12. The inductor device of claim 1, wherein the one or more inductor windings comprise:
a conductor,
printed circuit board (PCB)-based multi-layer windings,
Litz wire windings, and/or
stranded cables.

13. The inductor device of claim 1, wherein the one or more inductor windings comprise printed circuit board (PCB)-based multi-layer windings, each layer of PCB forming a certain winding clearance to create a circular distance from the respective air gap.

14. A converter, comprising an inductor device, wherein the inductor device comprises:
an inductor core; and
one or more inductor windings wound around the inductor core, wherein a part of the one or more inductor windings is at least partially embedded in the inductor core;
wherein a cross section of the inductor core comprises a four-sided winding window in which the at least partially embedded part of the one or more inductor windings is arranged;
wherein the inductor core comprises air gaps extending from the four sides of the winding window;
wherein the winding window comprises at each side of the winding window a respective winding clearance in which no inductor windings are arranged, wherein at least one of the four winding clearances has a non-uniform shape where a distance between a winding outline and a side or edge of the winding window is non-uniform.

15. The converter of claim 14, wherein the winding window with the winding clearances and the air gaps extending from the four sides of the winding window are formed in a winding restricted area of the inductor device; and
wherein the winding restricted area is formed by a projection of an outline of the inductor core onto the one or more inductor windings which overlaps the one or more inductor windings.

16. The converter of claim 14, wherein the inductor core comprises a top face and a bottom face in opposite direction to the top face; and
wherein the one or more inductor windings are wound around the inductor core in one or more planes between the top face and the bottom face.

17. The converter of claim 14, wherein at least two of the four winding clearances have a non-uniform shape.

18. The converter of claim 14, wherein a shape of the winding clearance has a circular-shaped, elliptically-shaped, square-shaped, rectangular shaped, triangular shaped or round convexity or indentation.
